(19) United States
(12) Patent Application Publication
(10) Pub. No.: US 2010/0229765 A1
(43) Pub. Date: Sep. 16, 2010

(54) Industrial pallets formed of recycled and/or scrap lumber and method of manufacturing

(76) Inventor: Bryan Shafer, West Valley City, UT (US)

Correspondence Address: MORRISS OBRYANT COMPAGNI, P.C., 734 EAST 200 SOUTH, SALT LAKE CITY, UT, 84102, US

(21) Appl. No.: 12/381,391

(22) Filed: Mar. 10, 2009

(51) Int. Cl. B65D 19/31; B65D 19/22; B65D 19/26; B23P 11/00

(52) U.S. Cl. 108/57.17; 108/57.33; 29/428

(57) ABSTRACT

This invention is industrial pallets formed of new, recycled and/or scrap lumber and methods of manufacturing same. The wood used to form the novel industrial pallet may include new scrap lumber that remains from conventional pallet manufacturing or old lumber from used pallets or other wood sources. Stringers according to various embodiments disclosed herein may be formed of new or old lumber, with standard or extra width, or include remanufactured or composite stringers of extra width that have been laminated together with fasteners or brackets for extra thickness and strength. A particular feature common with some embodiments of pallets described herein are short deck boards that have been butted together (end-to-end) at intermediate stringers to form the equivalent of a single full deck board. The short deck boards extend between adjacent stringers without extending beyond the two adjacent stringers spanned by any single short deck board. Top and bottom decks of pallets may be in an interdigitated or end-to-end configuration as well.

### BACKGROUND OF THE INVENTION

1. Field of the Invention

This invention relates generally to industrial pallets, and more particularly, the present invention relates to wooden industrial pallets. Still more particularly, embodiments of pallets according to the present invention may be formed from recycled and/or scrap lumber.

2. Description of Related Art

Industrial pallets are used as structural supports for transportation of goods in various contexts, including storage in warehouses, transportation using a forklift and on flatbeds or trailers of trucks or semi-tractor trailers. A typical wooden pallet may include two or more stringer boards running parallel to one another and a series of deck boards extending in spaced relation, crosswise of the stringers. The stringer boards may have cutouts running along bottom edges to accommodate forklift blades during transportation.

In conventional wooden pallets, the deck boards are cut to uniform length corresponding to the desired width of the finished pallet. Thus, depending on the lengths of the boards from which the deck boards are cut, short lengths of boards are left over. These short lengths of boards generally become scrap suitable for chipping, or may be bundled and sold for firewood, or simply burned by the manufacturer. It has become undesirable to waste good quality boards with the cost of lumber escalating.

One approach to using these short lengths of boards in industrial pallets has been proposed in U.S. Pat. No. 4,184,435 to Shevchenko. Shevchenko discloses various configurations of pallets with interdigitated deck boards. The interdigitated deck boards of Shevchenko all generally extend past an intermediate stringer in cantilever fashion. According to Shevchenko, this lateral interdigitating engagement of the short deckboards along the intermediate stringer improves the resistance of the pallet to “racking” which is defined as the resistance of the outboard stringers to movement relative to one another in response to a force applied axially thereto. The cantilevered interdigitating is also asserted to improve the versatility of the Shevchenko pallet by enabling it to support bags or barrels stacked in various arrangements. However, good boards that only extend the distance between adjacent stringers would still be scrap according Shevchenko because they are too short to achieve the desired cantilevering and would allegedly be susceptible to racking.

Generally, pallets can be reused over and over again. Industrial wooden pallets that have been used or recycled eventually may become broken or otherwise unsuitable for their original intended purpose. Such broken pallets may be repaired, remanufactured or become used scrap lumber. Recycled pallets may be graded according to various standards that relate to the level of repair that they have endured to become reusable. A brief description of exemplary grades of recycled pallets follows:

“Sam's A grade” pallets are generally a highest grade recycled pallet and are used in large wholesale club operations. Sam's A grade pallets do not have any plated stringer repairs, painted or colored stringers and all of these pallets have 6″ leading edge boards. No softwood lumber is used in Sam's A grade pallets-they are all hardwood. “Premium A grade” pallets are similar to Sam's A grade pallets. However, Premium A grade pallets may include some plated stringer repairs and colored (or painted) stringers. “Standard A grade” pallets have generally been repaired more often than either of the Sam's or Premium A grade pallets and may have leading edge boards with widths ranging from about 3″ to about 6″. Standard A grade pallets do not contain double or sister stringer repairs. “1 Stringer B grade (B+)” recycled pallets contain only 1 double or sister stringer repair per pallet. “B grade” pallets contain 1 or more double or sister stringer repairs per pallet. As a general rule, higher graded pallets command higher premiums in cost relative to the lower graded recycled pallets.

If a recycled pallet cannot be cost effectively repaired to one of the above grades, it generally becomes used scrap lumber. Used scrap lumber, damaged logs, wood waste and other wood by-products can be ground up and used for molded presswood or chipboard or particle board pallets, landscaping mulch and bedding for livestock etc. However, with the cost of new lumber escalating, it has become desirable to utilize used scrap lumber as well as new scrap lumber for pallets if possible.

Thus, it would be highly advantageous to provide industrial pallets formed from recycled or scrap lumber or boards that would otherwise be too short to use according to the teachings of Shevchenko and others in the prior art. It would also be advantageous to provide a manufacturing process for such novel recycled pallets.

### SUMMARY OF THE INVENTION

An embodiment of a pallet according to the present invention is disclosed. The pallet may include a top deck and a bottom deck parallel to, and spaced apart from, the top deck. The pallet may further include two outer stringers both attached between the top deck and the bottom deck and parallel to each other. The pallet may further include at least one intermediate stringer disposed between and parallel to the two outer stringers, wherein the at least one intermediate stringer is thicker than either of the two outer stringers.

Another embodiment of a pallet is disclosed according to the present invention. The pallet may include a top deck and a bottom deck parallel and spaced apart from the top deck. The pallet may further include two outer stringers both attached between the top deck and the bottom deck and parallel to each other. The pallet may further include an intermediate stringer disposed between and parallel to the two outer stringers. The decks of the pallet both further comprise short deck boards spanning from an outer stringer to the intermediate stringer without extending beyond the intermediate stringer.

An embodiment of a method of manufacturing a pallet is also disclosed. The method may include providing two outer stringers of a predetermined length, Iₛ. The method may further include providing at least one intermediate stringer of the predetermined length, Iₛ, wherein the at least one intermediate stringer comprises a thickness, tᵢ, greater than a thickness, tₒ, corresponding to either of the two outer stringers. The method may further include providing a plurality of full deck boards of a predetermined width, w_{fd}, and a predetermined length, I_{fd}. The method may further include providing a plurality of short deck boards of a predetermined width, w_{sd}, and a predetermined length, I_{sd}. The method may further include disposing each of the two outer stringers a predetermined distance apart from and parallel to the at least one intermediate stringer as measured from a centerline of the at least one intermediate stringer to a centerline of an adjacent outer stringer. The method may further include forming a top deck, comprising at least two full deck boards and at least two short deck boards, each short deck board extending between top surfaces of two adjacent stringers without extending beyond the two adjacent stringers. The method may further include forming a bottom deck, comprising at least two full deck boards and at least two short deck boards, each short deck board extending from bottom surfaces of two adjacent stringers without extending beyond the two adjacent stringers. The method may further include fastening the top deck and the bottom deck to the stringers.

Additional features and advantages of the present invention will be set forth in the description which follows, and in part will be apparent from the description of the exemplary embodiments disclosed, or may be learned by the practice of the present invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIGS. 1-3 are top, front and right side views of an embodiment of a pallet according to the present invention.

FIGS. 4-6 are top, front and right side views of another embodiment of a pallet according to the present invention.

FIG. 7 illustrates a side view of a stringer formed of two short stringer boards joined end-to-end at a joint with metal plates.

FIG. 8 is a close-up, cross-sectional view of an embodiment of an intermediate stringer mounted between a top deck and a bottom deck.

FIG. 9 illustrates a close-up cross-sectional view of another embodiment of an intermediate stringer comprised of a standard thickness stringer joined with thinner boards.

FIGS. 10A and 10B illustrate photographic images of an exemplary pallet constructed according to the illustrations in FIGS. 1-3.

FIG. 11 is a photographic image of a side view of an embodiment of a pallet having an outer stringer with a metal plate.

FIG. 12A is a photographic image of yet another embodiment of a pallet according to the present invention.

FIG. 12B is a photographic image of a close-up top view of the pallet shown in FIG. 12A illustrating greater detail of the intermediate stringer.

FIG. 12C is a photographic image of a side view of the pallet shown in FIGS. 12B and 12C, illustrating further detail of the intermediate stringer.

FIGS. 13A and 13B are photographic images of top and detail views, respectively, of an embodiment of a pallet constructed according to the present invention.

FIG. 14 is a detailed photographic image of an intermediate stringer having nominally 4″×4″ dimensions shown between two full deck boards, according to an embodiment of the present invention.

FIG. 15 illustrates another detailed photographic image of a standard width stringer having nominally 2″×4″ dimensions sandwiched in between two full deck boards, according to an embodiment of the present invention.

FIGS. 16A and 16B are photographic images of top and detail views, respectively, of an embodiment of a pallet constructed according to the present invention.

FIG. 17 is a photographic image of a metal plate suitable for joining two short stringer boards together to form a composite stringer board, according to an embodiment of the present invention.

FIGS. 18-20 illustrate views of a pallet having two thick intermediate stringers, according to the present invention.

FIG. 21 is a flowchart of an embodiment of a method of manufacturing a pallet according to the present invention.

### DETAILED DESCRIPTION

The invention is industrial pallets formed of recycled and/or scrap lumber and methods of manufacturing same. The wood used to form the novel industrial pallet may include new scrap lumber that remains from conventional pallet manufacturing or old lumber from used pallets or other wood sources. Stringers according to various embodiments disclosed herein may be formed of new or old lumber, with standard or extra width, or include remanufactured or composite stringers of extra width that have been laminated together, lengthwise or end-to-end, with metal plates, fasteners or brackets for extra thickness and strength. A particular feature common with some embodiments of pallets described herein are short deck boards that have been butted together (end-to-end) at intermediate stringers to form the equivalent of a single full deck board. The short deck boards extend between adjacent stringers without extending beyond the two adjacent stringers spanned by any single short deck board. The use of medium deck boards to extend over precisely three stringers and no further is also contemplated for further embodiments of top and bottom decks according to the present invention. Top and bottom decks of pallets may be in an interdigitated or end-to-end configuration as well.

Composite lumber that has been joined end-to-end with finger joints or dove-tail joints and adhesive or other fasteners may also be used in the constructions of the novel pallets herein. Similarly, composite lumber that has been joined end-to-end using lap joints and adhesives or fasteners may also be used in the constructions of the novel pallets herein. The use and application of finger, dove-tail and lap joints for joining shorter pieces of lumber together to form longer pieces of lumber is well known to those of ordinary skill in the art and, thus, will not be further elaborated on herein.

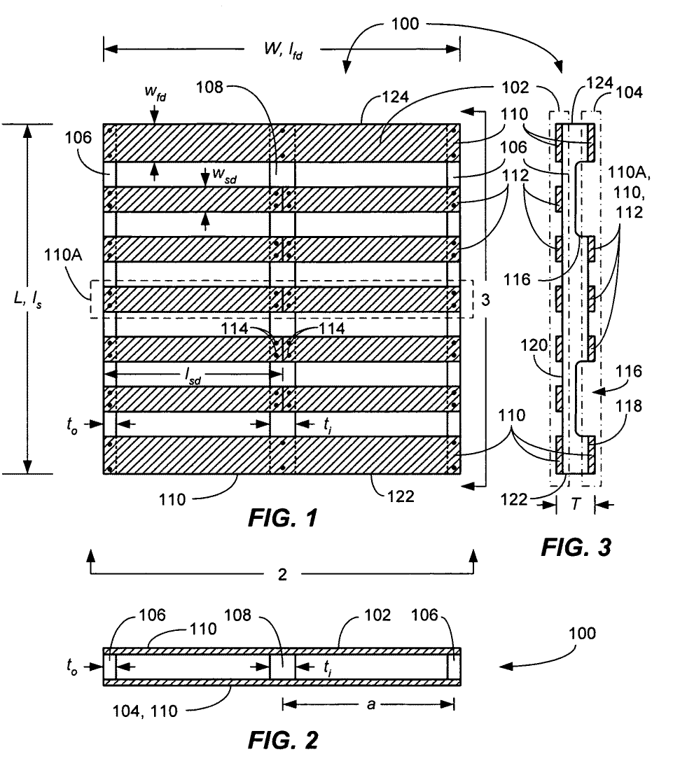

FIGS. 1-3 illustrate top, front side and right side views of an embodiment of a pallet 100 according to the present invention. Pallet 100 may include a top deck 102 (shown in cross-hatched top deck boards 110 and 112 in FIG. 1 and within dot-dash box 102 in FIG. 3). Pallet 100 may also include a bottom deck 104 (not shown in FIG. 1, but see FIG. 2 and within dot-dash box 104 in FIG. 3). Pallet 100 may further include two outer stringers 106 and at least one intermediate stringer 108 (one shown in FIGS. 1-2). The top deck 102 and bottom deck 104 are parallel to each other and spaced apart from each other by stringers 106 and 108.

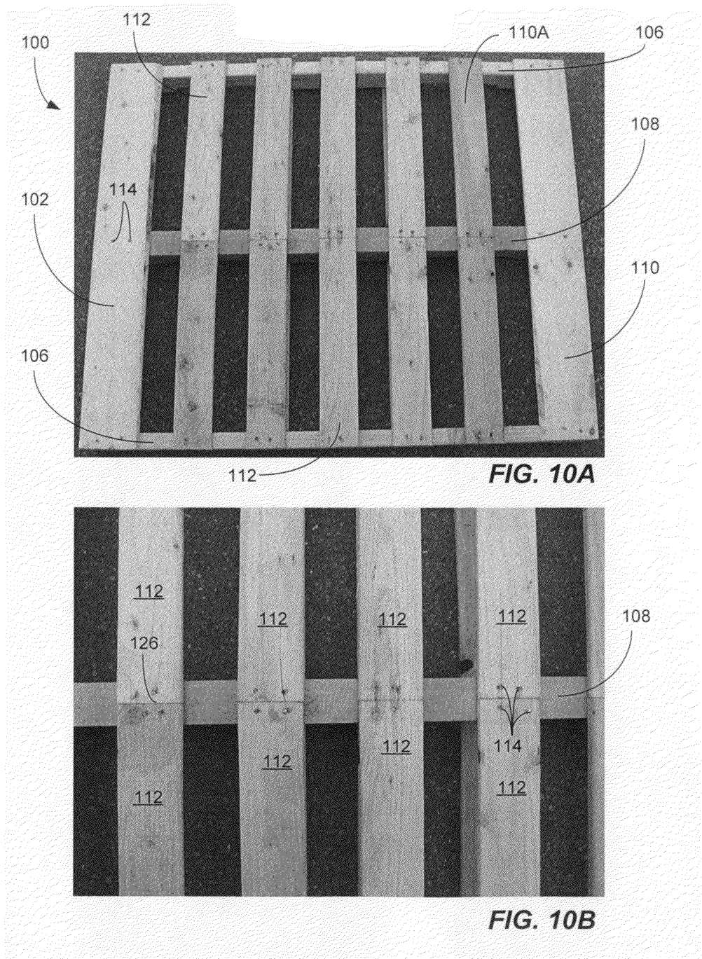

FIGS. 10A and 10B illustrate photographic images of an exemplary pallet 100 constructed according to the illustrations in FIGS. 1-3. More specifically, FIG. 10 is a top perspective view of a pallet 100. FIG. 10B is a close-up top view of the top deck 102 comprised of short deck boards 112 fastened to an intermediate stringer 108. The extra width of intermediate stringer 108 provides the necessary room for the butt joint 126 of adjacent short deck boards 112. The intermediate stringer 108 in the embodiment of FIGS. 10A-10B is a length of nominally 4″×4″ lumber. The term “nominally” is used herein because the actual board dimensions may be less depending on the amount of planing that has been performed on the lumber used to form the pallet component boards. Such nominal dimensions and actual smaller board thickness dimensions are well known to those of skill in the art.

Referring to FIG. 10A, the top deck 102 is comprised of 5 pairs 110A of short deck boards 112 mounted end-to-end and two full deck boards 110. The top deck is supported by the intermediate stringer 108 and two outer stringers 106. Each short deck board 112 or full deck board 110 is fastened to the stringers 106, 108 by fasteners 114. In the embodiment of FIGS. 10A-B, the fasteners 114 are nails.

The intermediate stringer 108 may have a thickness, ti, that is greater than the thickness, tₒ, of outer stringers 106, see, FIGS. 1-2. For example, in one embodiment of a pallet 100, two outer stringers 106 may be formed of nominally 2″×4″ boards and an intermediate stringer may be formed of nominally 3″×4″ boards. Thus in this embodiment, thickness, tₒ, is about 2″ in thickness and thickness, tᵢ, is about 3″.

As best shown in FIG. 1, top deck 102 may include a pair of full deck boards 110, sometimes referred to as leading edge boards 110 disposed on upper surfaces 120 of the stringers 106 and 108, shown on the front 122 and rear edges 124 of the top deck 102. Top deck 102 may further include a plurality of short deck boards 112 (ten shown in FIG. 1) disposed in pairs, end-to-end and parallel to the full deck boards 110. Full deck boards 110 may be comprised of a single board of lumber (as shown in FIGS. 1-2). Alternatively, full deck boards 110A (FIG. 1) may be a composite of two short deck boards 112 disposed end-to-end. The short deck boards 112 and full deck boards 110 may be fastened to the stringers 106 and 108 with fasteners 114 (shown as black dots in FIG. 1). Fasteners 114 may be, for example and not by way of limitation, nails, staples, screws, brackets, adhesives or any other suitable fastener 114 or combination of the above known to those of ordinary skill in the art.

As best shown in FIG. 3, bottom deck 104 may include a pair of full deck boards 110, or leading edge boards 110 disposed on the front 122 and rear 124 edges of the bottom deck 104. According to one embodiment, top deck 102 may further include a plurality of short deck boards 112 disposed in pairs, end-to-end (e.g., 110A in dashed line box, FIG. 1) that are located inside, and parallel to, the two outer full deck boards 110. Five of such pairs (110A) of short deck boards 112 are shown in the top deck 102 of FIG. 1. According to alternative embodiments, one or more pairs (110A) of short deck boards may be replaced by full deck boards 110.

FIG. 3 also illustrates two forklift blade slots or cutouts 116 formed along a bottom surface 118 in each of the outer stringers 106. According to one embodiment of a pallet 100, the stringers 106, 108 each comprise two forklift blade slots 116 disposed along a bottom surface 118 of the stringers 106, 108. In this embodiment of pallet 100, the forklift blade slots 116 are aligned to receive a forklift blade (not shown). Each forklift blade slot 116 forms an opening between the pallet 100 and the surface upon which it is resting, e.g., ground (not illustrated in FIGS. 1-3). Each forklift blade slot 116 is configured to receive a blade from a forklift (not shown) when the pallet 100 is moved. Forklift blade slots 116 and their configurations in outer stringers 106 are well known to those of ordinary skill in the art.

An exemplary embodiment of a pallet 100 may include a top deck 102 and a bottom deck 104, wherein the bottom deck 104 is parallel to, and spaced apart from, the top deck 102. According to this embodiment, pallet 100 may further include two outer stringers 106, both outer stringers 106 attached between the top deck 102 and the bottom deck 104 and parallel to each other. Pallet 100 may further include at least one intermediate stringer 108 disposed between and parallel to the two outer stringers 106, wherein the at least one intermediate stringer 108 is thicker than either of the two outer stringers 106.

According to another embodiment of pallet 100, the top deck 102 may include a plurality of parallel full deck boards 110, wherein at least one of the plurality of full deck boards 110A comprises at least two short deck boards 112 disposed end-to-end at the at least one intermediate stringer 108. According to a particular embodiment of pallet 100, the two outermost parallel full deck boards 110 are integral, i.e., a single board of lumber, and all inner full deck boards 110A comprise two short deck boards 112 disposed end-to-end at a single intermediate stringer 108, see, e.g., FIG. 1.

According to another embodiment of pallet 100, the bottom deck 104 may include a plurality of parallel full deck boards 110, wherein at least one of the plurality of full deck boards 110A is formed from at least two short deck boards 112 joined end-to-end at the at least one intermediate stringer 108. According to another embodiment of pallet 100, the two outermost parallel full deck boards 110 are integral and all inner full deck boards 110A comprise two short deck boards 112 disposed end-to-end at the intermediate stringer 108.

The surface dimensions or sizes of pallets according to the present invention may generally be described with reference to a width by length (W×L) dimension, see FIG. 1. Width, W, generally corresponds to full deck board 110 length, I_{fd}. Length, L, generally corresponds to stringer length, Iₛ. Standard sizes of industrial pallets according to the present invention may include, but are not limited to: 48″×40″ 4-way entry pallets, 48″×48″ drum pallets, 1.2×1.0 meter Euro pallets, 1.2×0.8 meter Euro pallets, 42″×42″ pallets, 36″×36″ pallets, 56″×44″ bulk pallets, 44″×56″ bulk pallets and 48″×42″ pallets. Thus, pallets 100 according to the present invention may have approximate W×L dimensions selected from the following: 48″×40″, 48″×48″, 42″×42″, 36″×36″, 56″×44″, 48″×42″, 1.2 m×1.0 m, 1.2 m×0.8 m or any other suitable dimensions.

The overall thickness of a pallet according to the present invention depends in part on the size of stringers used, generally about 4″ or about 6″ in width plus the thickness of the deck boards used to form the top deck 102 and the bottom deck 104. Thus, pallets according to the present invention are generally of a thickness, T, ranging from about 4″ to about 8″, see FIG. 3. Of course, it will be understood that the inventive concepts of the present invention may be applied to pallets of any suitable dimensions, W×L×T.

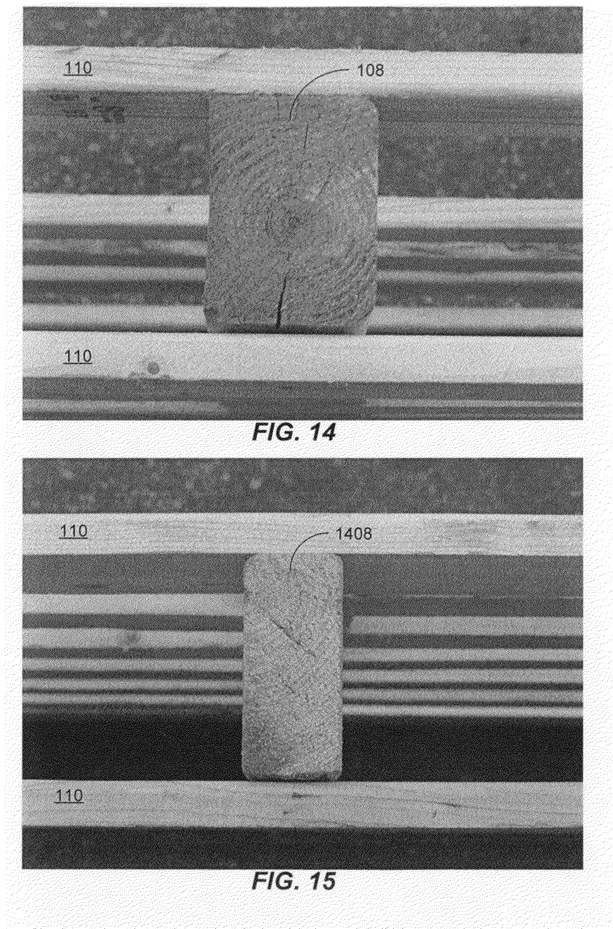

Referring to FIG. 1, deck boards 110, 112, may be of any suitable thickness, but are generally in the range from about 0.75″ to about 1.5″. Full deck boards 110 are of length, I_{fd}, and width, w_{fd}. According to exemplary embodiments of the present invention, width, w_{fd}, may be approximately 6″ or approximately 4″. Of course, any suitable width, w_{fd}, may be used in the full deck boards 110 of the present invention. Short deck boards 112 are of length, I_{sd}, and width, w_{sd}. According to exemplary embodiments of the present invention, width, w_{sd}, may be approximately 6″ or approximately 4″. Of course, any suitable width, w_{sd}, may be used in the short deck boards 112 of the present invention. Length, I_{sd}, of the short deck board 112 is generally about half the full deck board 110 length, I_{fd}, according to the embodiment of pallet 100 shown in FIG. 1. According to one embodiment, the two outer stringers 106, each comprise a predetermined length, Iₛ, of nominally 2″×4″ lumber. According to one embodiment of pallet 100, the intermediate stringer 108 may be formed of a length, Iₛ, of nominally 3″×4″ lumber, see FIG. 1. For example, please refer to FIG. 14, where a detailed photographic image of an intermediate stringer 108 having nominally 4″×4″ dimensions is shown between two full deck boards 110, according to an embodiment of the present invention. By comparison, FIG. 15 illustrates another detailed photographic image of a standard width intermediate stringer 1408 having nominally 2″×4″ dimensions, sandwiched in between two full deck boards 110, according to an embodiment of the present invention.

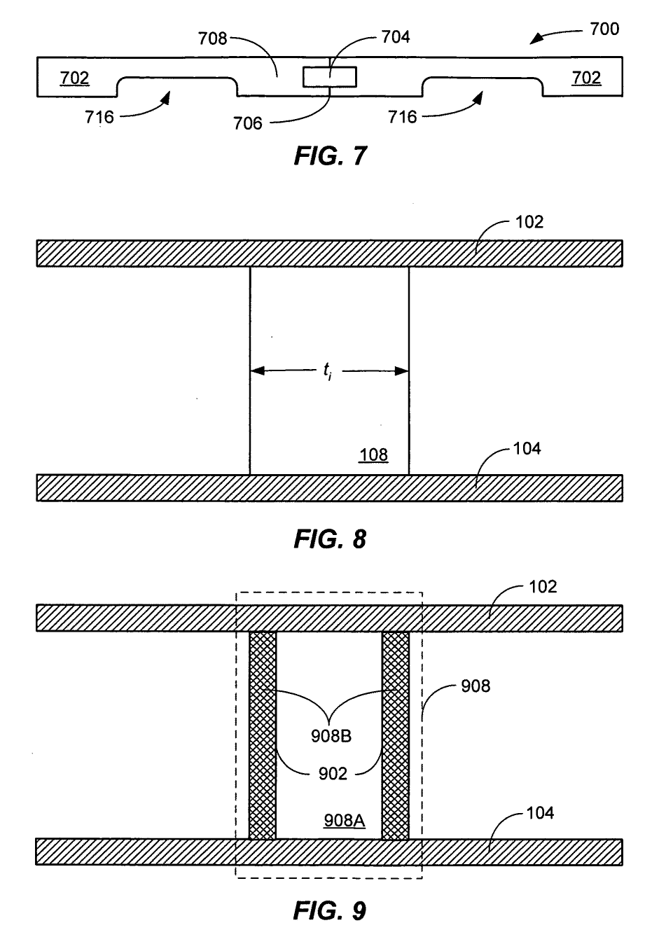

Referring to FIG. 7, a side view of a stringer 700 formed of two short stringer boards 702 joined end-to-end at joint 706 with two metal plates 704 (one shown) is illustrated. Metal plates 704 may be rectangular or any other suitable shape. Metal plates 704 may include integral prongs configured for insertion into the wood surface 708 of a stringer using a hammer, mallet or press. Such integral-pronged metal plates 704 are well known in the art. Alternatively, metal plates 704 may be configured with holes for receiving fasteners such as nails, screws, staples and the like as known to those skilled in the art. Each short stringer board 702 may also include a fork lift blade slot 716 (one each in FIG. 7). An example of a metal plate 1704 commonly used in the pallet construction industry is shown attached to an outer stringer 1706 in the detailed photographic image of FIG. 17. FIG. 17 also illustrates short deck boards 1712 attached to outer stringer 1706.

According to another embodiment of a pallet according to the present invention, at least one of the stringers 106, 108 comprises two short stringer boards 702 joined end-to-end with two metal plates. For example and not by way of limitation, stringer 700 might be substituted for any of the stringers 106, 108 shown in FIGS. 1-3. According to one embodiment of pallet 100, the intermediate stringer 108 may be formed of two short lengths of nominally 3″×4″ lumber formed into short stringer boards 702 joined together end-to-end with two metal plates 704. According to another embodiment of pallet 100, the intermediate stringer comprises two short lengths of nominally 3″×6″ lumber that have been formed into short stringer boards 702 joined together end-to-end with two metal plates 704.

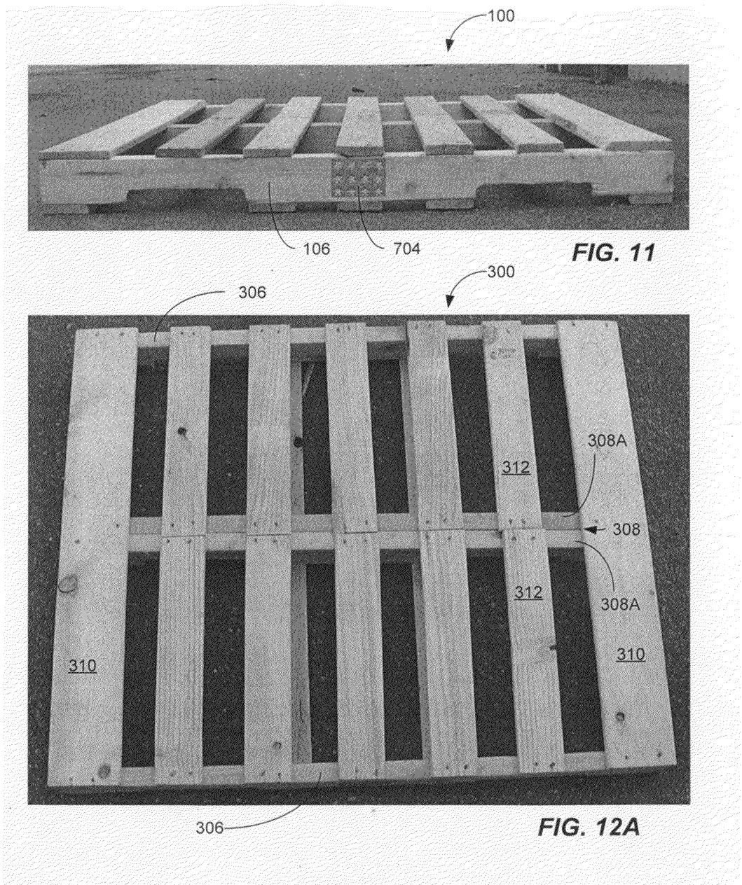

FIG. 11 is a photographic image of a side view of an embodiment of a pallet 100 having an outer stringer 106 with a metal plate 704. Metal plate 704 includes integrated prongs (not shown) as described herein with reference to FIG. 7, that are configured to be pressed into the wood of outer stringer 106. Metal plates 704 are conventionally used to provide structural integrity to split or cracking lumber. The novel use of metal plates 704 herein is for joining two short stringer boards (702, FIG. 7), that might otherwise be scrap. Applicant is presently unaware of anyone who butt joins two short stringer boards (702, FIG. 7) to form an integrated stringer 106 or 108 in a pallet 100.

FIG. 8 is a close-up, cross-sectional view of an embodiment of an intermediate stringer 108 having thickness, tᵢ, mounted between a top deck 102 and a bottom deck 104. Intermediate stringer 108 thickness, tᵢ, could be nominally 3″ or 4″ according to a couple of embodiments of pallet 100. The extra thickness, tᵢ, of this intermediate stringer 108 provides ample space to butt joint short deck board at the intermediate stringer 108, see for example FIG. 1.

FIG. 9 illustrates another close-up cross-sectional view of an embodiment of an intermediate stringer, shown in dashed box 908, which is comprised of a standard thickness stringer 908A made thicker by joining or laminating thinner boards 908B to both outer surfaces 902 of the standard thickness stringer 908A. The joining or lamination of standard thickness stringer 908A to thinner boards 908B may be achieved by adhesives, fasteners (nails, brads, screws, staples, etc.) or any other means (none shown in FIG. 9 for ease of illustration) known to those of ordinary skill in the art. According to one embodiment, intermediate stringer 908 comprises a nominal 2″×4″ standard thickness stringer 908A with two 1″×4″ thinner boards laminated at the outer surfaces 902. According to another embodiment, the intermediate stringer 908 may be formed of two identical lengths of nominally 1″×6″ lumber 908B attached to opposing sides 902 of the identical length of nominally 2″×6″ lumber 908A to form the identical length of a laminated intermediate stringer 908 having dimensions of nominally 4″× about 6″.

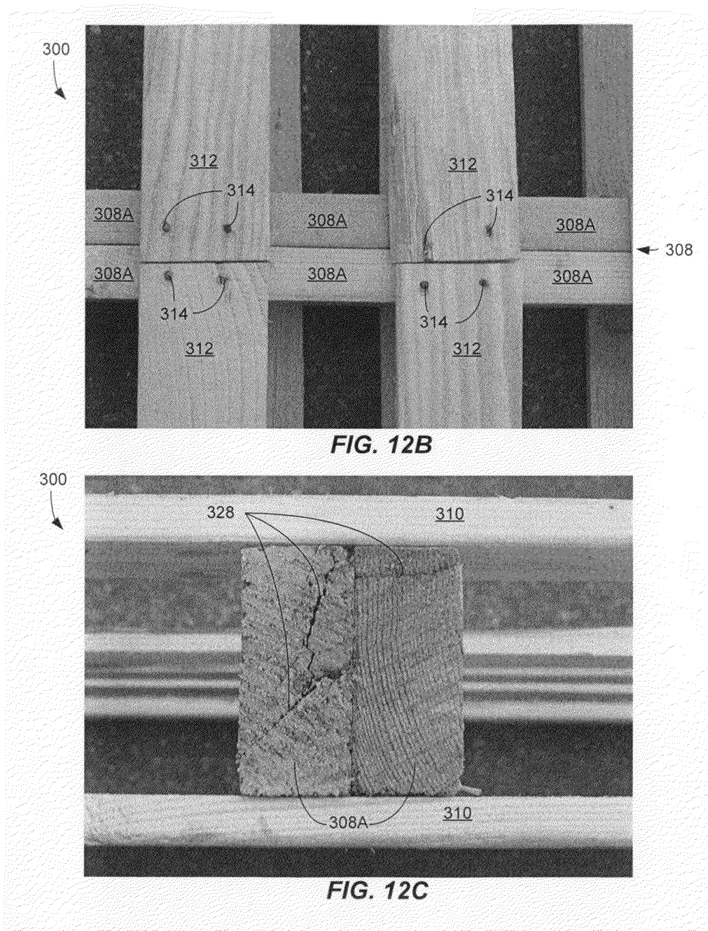

FIG. 12A is a photographic image of yet another embodiment of a pallet 300 according to the present invention. According to the pallet 300 shown in FIG. 12, the double-thickness intermediate stringer 308 may be formed of two standard thickness stringers 308A, each of identical length. In the exemplary embodiment shown in FIG. 12A, two standard stringers 308A of nominal dimensions 2″×4″ are joined together to form laminated double-thickness intermediate stringer 308, thus having combined nominal dimensions of 4″×4″. According to one embodiment of pallet 300, each standard thickness stringer 308A used to form laminated double-thickness stringer 308 may be of roughly the same dimensions as outer stringers 306.

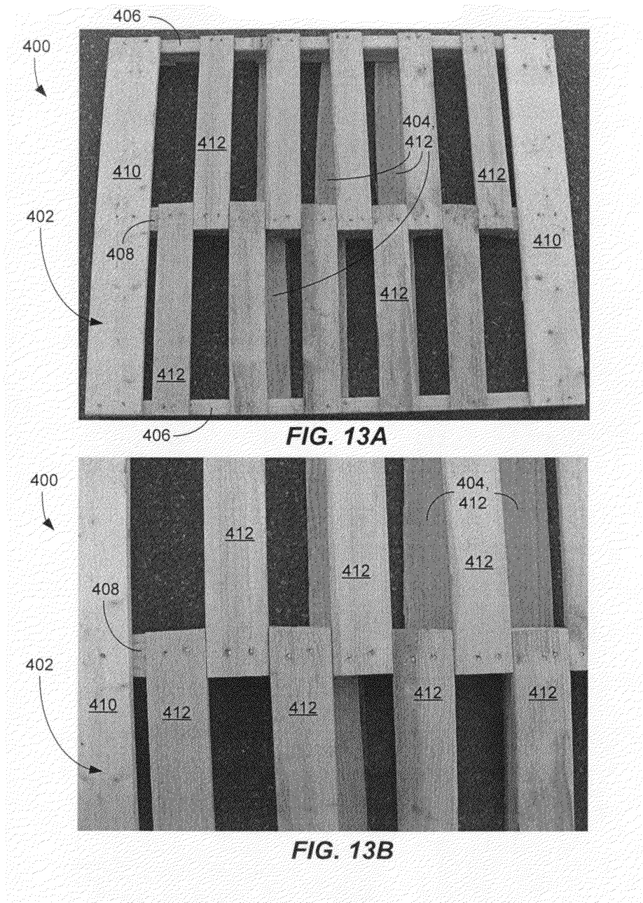

FIG. 12B is a photographic image of a close-up top view of pallet 300 shown in FIG. 12A illustrating greater detail of intermediate stringer 308. FIG. 12B illustrates two standard thickness stringers 308A that have been fastened together to form a double-thickness intermediate stringer 308. FIG. 12B also illustrates a plurality of short deck boards 312 (four shown) joined end-to-end on top of the double-thickness intermediate stringer 308 using nails 314. Of course, it will be understood that any fastener (114 FIG. 1) could be used, not just the nails 314 shown in FIG. 13. For example and not by way of limitation, brads, staples, screws, brackets and adhesives may be used to secure the short deck boards 312 to the double-thickness intermediate stringer 308. It will also be understood that the “extra thickness” of the double-thickness intermediate stringer 308 shown in FIGS. 12-14, as well as the intermediate stringer 108 shown in FIGS. 1-2, allows some misalignment of the short deck boards 112, 312 to occur during manufacturing without affecting pallet strength according to the present invention.

FIG. 12C is a photographic image of a side view of pallet 300 illustrating further detail of the double-thickness intermediate stringer 308 shown in FIGS. 12-13. As shown in FIG. 12C, the double-thickness intermediate stringer 308 is sandwiched between two full deck boards 310. FIG. 12C illustrates two standard thickness stringers 308A formed for example by two identical lengths of nominally 2″×4″ lumber. According to yet another embodiment of pallet 300, the intermediate stringer 308 may be formed of two identical lengths, L, of nominally 2″×6″ lumber joined together to form the identical length, L, of a laminated, or double-thickness, intermediate stringer 308 having dimensions of nominally 4″× about 6″. Because of the structural integrity inherent in the double-thickness intermediate stringer 308, there is tolerance for lumber that may have cracks 328 or knots (not shown) or other natural variations in the lumber used in the standard thickness stringers 308A that are used to form the double-thickness intermediate stringer 308 without affecting overall pallet strength.

Referring again to FIG. 3, the two outer stringers 106 may each comprise a length, L, of nominally 2″×6″ lumber, according to one embodiment of pallet 100. Referring again to FIGS. 1 and 2, the intermediate stringer 108 may be formed of a length, L, of nominally 3″×6″ lumber, according to another embodiment of pallet 100. According to still another embodiment of pallet 100, the intermediate stringer 108 may be formed of a length, L, of nominally 4″×6″ lumber. Of course it will be understood that these exemplary dimensions of outer 106 and intermediate stringers 108 are not limiting of the present invention. Rather, the pallets and component parts such as outer 106 and intermediate stringers 108 disclosed herein are only limited by the availability of lumber and its predetermined dimensions from a lumber source, or a manufacturer's ability to form stringers with any suitable dimensions.

Another embodiment of a pallet 100 is disclosed. This embodiment of a pallet 100 includes a top deck 102 (FIGS. 1-3) and a bottom deck 104 (FIGS. 2-3) parallel and spaced apart from the top deck 102. This embodiment of a pallet further includes two outer stringers 106 (FIGS. 1-3) each of the two outer stringers 106 attached between the top deck 102 and the bottom deck 104 and parallel to each other. This embodiment of a pallet further includes an intermediate stringer 108 (FIGS. 1-2) disposed between and parallel to the two outer stringers 106. According to this embodiment of a pallet 100, the decks 102 and 104 both further comprise short deck boards 112 spanning from an outer stringer 106 to the intermediate stringer 108 without extending beyond the intermediate stringer 108. The pallet 100 shown in FIGS. 1-3 conforms to this particular embodiment of a pallet. According to a further embodiment, two short deck boards 112 are disposed end-to-end at the intermediate stringer 108. This further embodiment also conforms to pallet 100 shown in FIGS. 1-3.

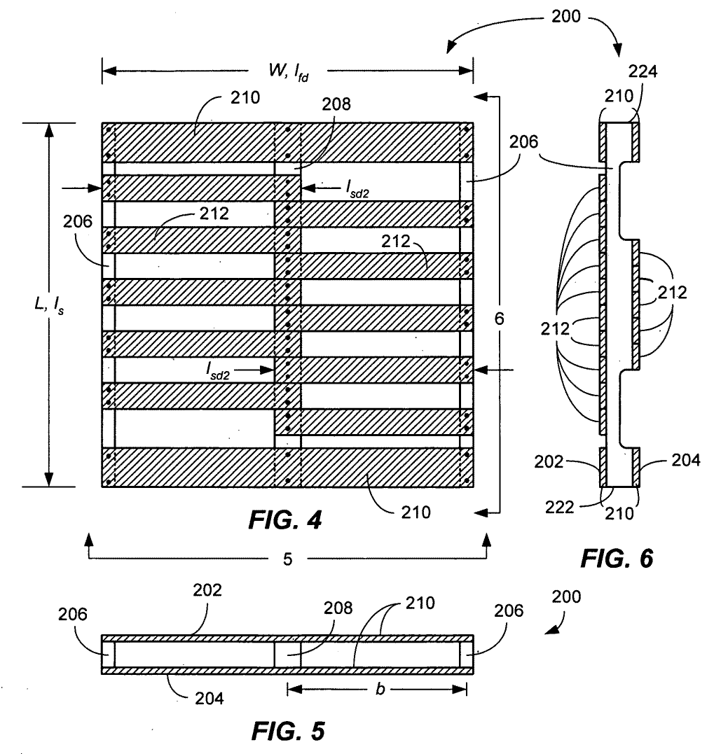

FIG. 4 illustrates a top deck view of another embodiment of a pallet 200 according to the present invention. The bottom deck 204 is not shown in FIG. 4. According to pallet 200, the short deck boards 212 extend from the outer stringers 106 to the intermediate stringer 108 in an interdigitated relationship without extending beyond the intermediate stringer 108. This is in contrast to the butt joints formed of short deck board 112 of FIGS. 1-3. However, with both embodiments of pallet 100 and 200, the short deck boards 112 and 212 do not extend beyond corresponding intermediate stringers 108 and 208. FIG. 5 is a front side view of the pallet 200 shown in FIG. 4. FIG. 6 is a right side view of the pallet 200 shown in FIGS. 4-5. According to the embodiment of pallet 200 illustrated in FIG. 4, short deck boards 212 are adjacent to one another at the intermediate stringer 208. However, according to other embodiments, there may be spacing between adjacent short deck boards 212. Each short deck board has a length, I_{sd2}, extending from the top of the intermediate stringer 208 to the top of an outer stringer 206 without extending beyond either the outer stringer 206 or the intermediate stringer 208.

As shown in FIGS. 4-5, the intermediate stringer 208 is thicker than either of the outer stringers 206. According to one embodiment of pallet 200 the intermediate stringer 208 may be formed from two identical lengths of nominally 2″×4″ boards joined together to form a composite intermediate stringer having dimensions of about 4″ by about 4″. For example and not by way of limitation, see FIG. 12B and related discussion herein. According to another embodiment of pallet 200 the intermediate stringer 208 may be formed from a nominally 2″×4″ board surrounded and joined by two nominally 1″×4″ boards, thereby forming a composite intermediate stringer having dimensions of about 4″× about 4″. For example and not by way of limitation, see FIG. 9 and related discussion herein. According to yet another embodiment of pallet 200 the intermediate stringer 208 may be formed from two short, nominally 4″×4″ stringer boards joined end-to-end with steel plates to form a composite nominally 4″×4″ intermediate stringer. For example and not by way of limitation, see FIG. 7 and related discussion herein.

As best shown in FIG. 6, bottom deck 204 may include a pair of full deck boards 210, or leading edge boards 210 disposed on the front 222 and rear 224 edges of the bottom deck 104. According to one embodiment, top deck 102 may further include a plurality of short deck boards 212 (five shown) that are disposed parallel to the two outer full deck boards 210 and run from an outer stringer 206 to the intermediate stringer 208 (not shown in FIG. 6 but similar to short deck boards 212 on the top deck 202).

FIGS. 13A and 13B are photographic images of a top and a detailed view of an embodiment of a pallet 400 constructed according to the present invention. As shown in FIGS. 13A and 13B, pallet 400 includes, a bottom deck 404, two outer stringers 406, a thick intermediate stringer 408 and a top deck shown generally at arrow 402 formed of short deck boards 412 and full deck boards 410. The bottom deck 404 is mostly obscured by top deck 402, but see 404 in FIGS. 13A and 13B indicating short deck boards 412 on the bottom deck 404. Like pallet 200, the short deck boards 412 of pallet 400 are interleaved or interdigitated and adjacent to one another on the thick intermediate stringer 408. Also, note that the short deck boards 412 of pallet 400 generally run from an outer stringer 406 to the intermediate stringer 408 without extending beyond the intermediate stringer 408. The same is true for short deck boards 412 on the bottom deck 404.

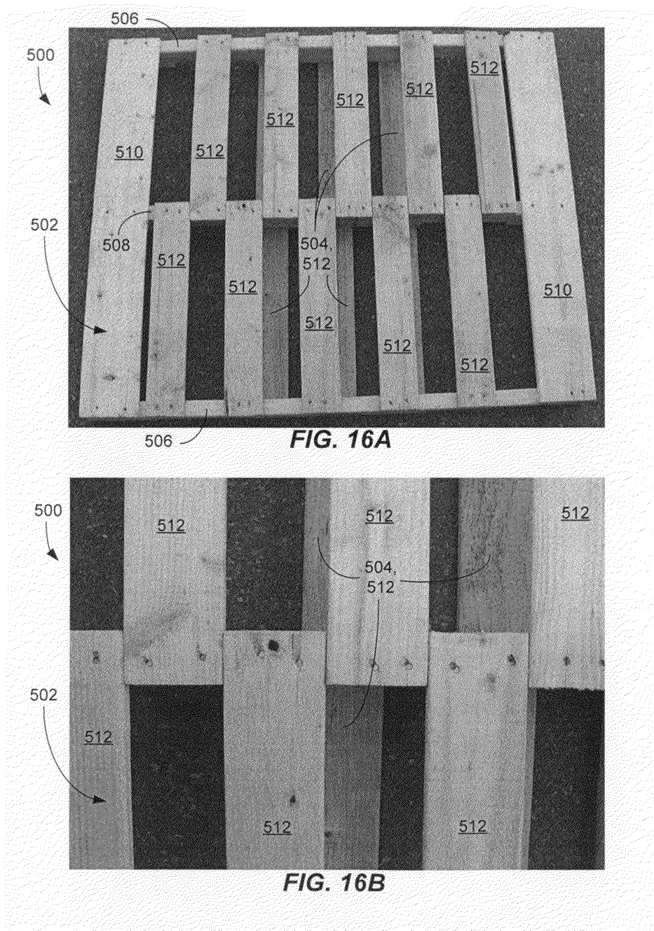

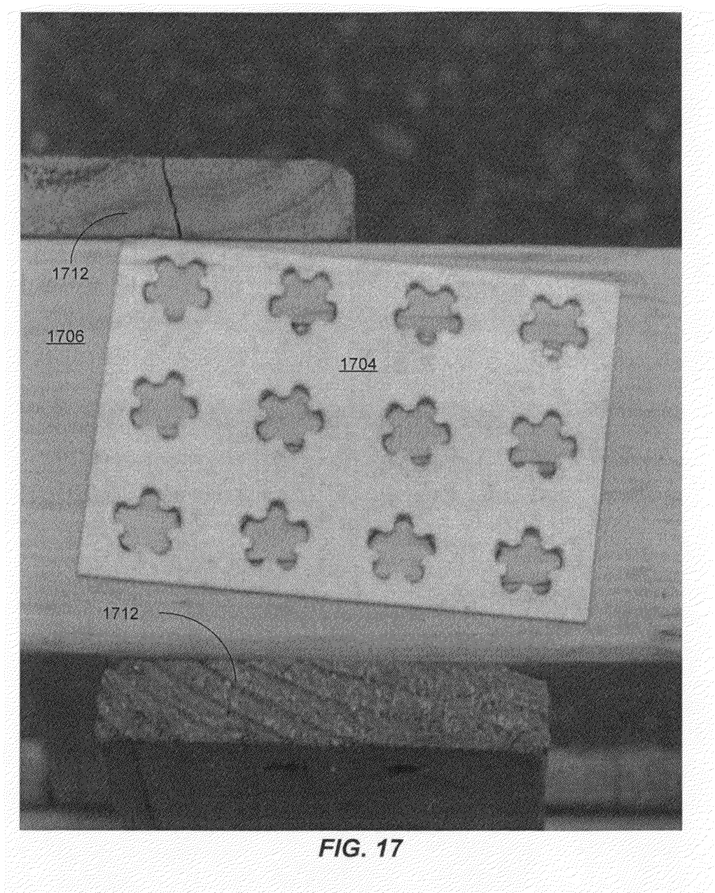

FIGS. 16A and 16B are photographic images of a top and a detailed view of an embodiment of a pallet 500 constructed according to the present invention. As shown in FIGS. 16A and 16B, pallet 500 includes a bottom deck 504, two outer stringers 506, a standard thickness intermediate stringer 508 and a top deck, shown generally at arrow 502 formed of short deck boards 512 and full deck boards 510. The bottom deck 504 is mostly obscured by top deck 502, but see 504 in FIGS. 16A and 16B pointing to short deck boards 512 on the bottom deck 504. Like pallet 200, the short deck boards 412 of pallet 400 are interleaved or interdigitated and adjacent to one another on the standard thickness intermediate stringer 508. Also, note that the short deck boards 512 of pallet 500 generally run from an outer stringer 506 to the intermediate stringer 508 without extending beyond the intermediate stringer 508. The same is true for short deck boards 512 on the bottom deck 504. It will also be understood that with the interdigitated short deck boards 512, the standard thickness intermediate stringer 508 has sufficient width for attachment of the short deck boards 512. Thus, a thick intermediate stringer (like 408 in FIGS. 13A and 13B) are not necessarily required for such an interdigitated pallet, e.g., pallet 400 and 500.

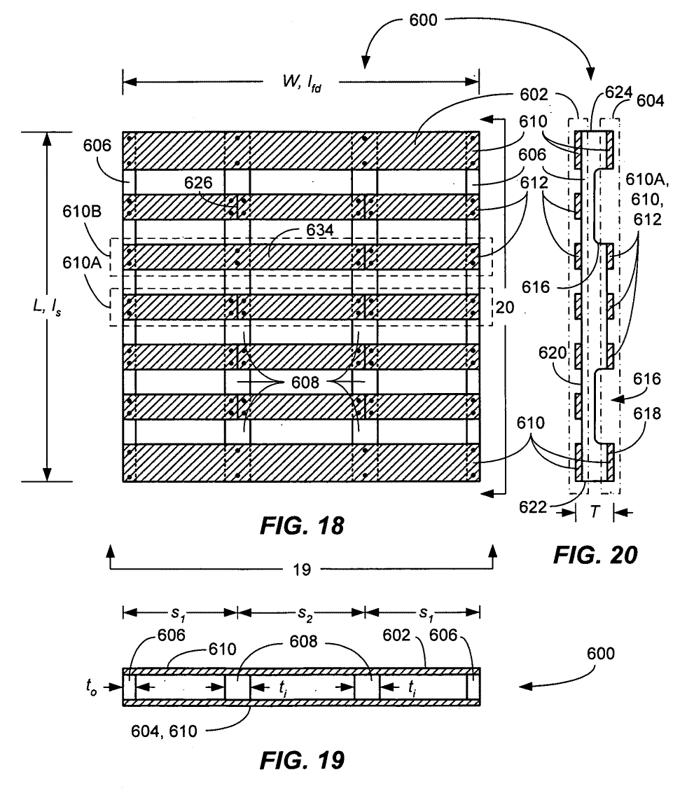

The pallets according to the present invention need not be limited to a single intermediate stringer 108, e.g., pallets 100 and 300. FIGS. 18-20 illustrate views of pallet 600 having two thick intermediate stringers 606, according to the present invention. More particularly, FIGS. 18-20 illustrate top, front and right side views, respectively, of pallet 600.

Referring to FIGS. 18-20, pallet 600 includes a top deck 602 and a bottom deck 604 separated by two outer stringers 606 and two thick intermediate stringers 608. Top deck 602 is fastened to upper surfaces 620 of stringers 606 and 608. Bottom deck 604 is attached to bottom surfaces 618 of stringers 606 and 608. According to one embodiment of pallet 600, the two intermediate stringers 608 are evenly spaced (not illustrated in FIGS. 18-19 between the two outer stringers 606. According to other embodiments of pallet 600, the spacing, s₁, between the outer stringers 608 and the intermediate stringers 608 may be different from the spacing, s₂, between the two intermediate stringers 608, see dimensionse s₁ and s₂ between FIGS. 18 and 19. It will be evident that the spacing between stringers 606 and 608 is limited, but may be selected to accommodate spacing for receiving a forklift blade (not shown) if four-sided entry by forklift (also not shown) to the pallet 600 is desired or to accommodate identical lengths of short deck boards 612, i.e., s₁=s₂, according to various embodiments of pallet 600

Top deck 602 (best shown in cross-hatching 602 in FIG. 18 and dot-dash box 602 in FIG. 20) further includes two leading or full deck boards 610 at front 622 and rear 624 ends of the pallet 600 and a plurality of short deck boards 612 extending between adjacent stringers 606, 608. According to the illustrated embodiment of pallet 600, the short deck boards 612 form butt joints 626 (end-to-end, see FIG. 18) at the intermediate stringers 608. Three short deck boards 612 joined end-to-end at the intermediate stringer 608 forms a composite full deck board, shown in dashed box at 610A. It will be evident that other variations on the composite full deck board are also possible. For example, a medium deck board 634 may be joined end-to-end with a short deck board to form another embodiment of a composite full deck board 610B (also shown in dashed box). Thus, for composite full deck board 610B, a medium deck board 634 may replace two short deck boards 612. According to the embodiment of pallet 600 illustrated in FIG. 20, all stringers (outer 606 and intermediate 608) may be configured with forklift blade slots 616 to accommodate forklift blades (not shown) during transportation of the pallet 600 (loaded or not) with a forklift (also not shown).

While five composite full deck boards 610A or fifteen short deck boards 612 are shown in FIG. 18, any suitable number of short deck boards 612 may be used to form any suitable number of composite full deck boards 610A. For example and not by way of limitation, rather than constructing pallet 600 with five composite full deck boards 610A, only three composite full deck boards 610A might be used and the other two may be full deck boards 610. All such combinations are considered to be within the scope of the present invention. Furthermore, it will be evident from the teachings herein that the end-to-end short deck board 612 configuration shown in FIGS. 18-20, may be modified to incorporate an interdigitated short deck board configuration (not shown) with the two intermediate stringers 608. Such an “interdigitated, two intermediate stringer configuration” may include thick intermediate stringers 608 or standard width (or thickness) intermediate stringers (see, 1408, FIG. 15). It will also be evident that the pattern of interleaving of the interdigitated short deck boards 612 may be varied significantly according to various possible layouts and requirements of the intended payload for which the pallet 600 is configured to support. Similarly, the bottom deck 604 is shown with two full deck boards 610 at ends 622 and 624.

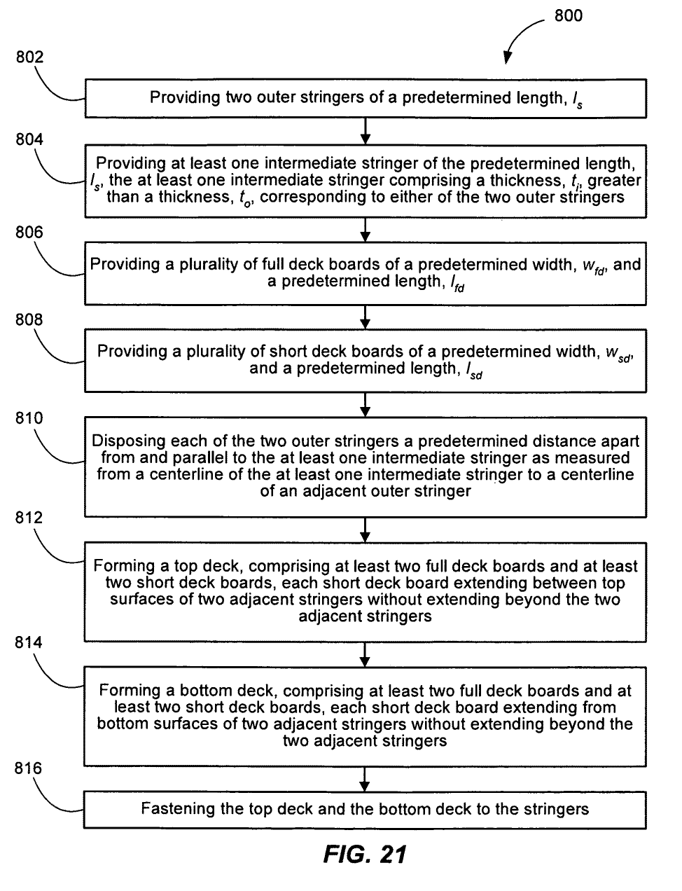

FIG. 21 is a flowchart of an embodiment of a method of manufacturing a pallet 800 according to the present invention. Method 800 may include providing two outer stringers 802 of a predetermined length, Iₛ. According to embodiments of the method of manufacturing pallet 800, any of the outer stringers 106, 206, 306, 406, 506 and 606 described herein may be provided according to method step 802.

Method 800 may further include providing at least one intermediate stringer 804 of the predetermined length, Iₛ, the at least one intermediate stringer comprising a thickness, tᵢ, greater than a thickness, tₒ, corresponding to either of the two outer stringers. Method 800 contemplates pallet manufacturing with a single intermediate stringer 108, 208, 308, 408 and 508 of any thickness or composition, laminated or integral as described herein. Method 800 further contemplates pallet manufacturing with two or more intermediate stringers 608 of any thickness or composition, laminated or integral as described herein.

Method 800 may further include providing a plurality of full deck boards 806 of a predetermined width, w_{fd}, and a predetermined length, I_{fd}. According to embodiments of method 800, the full deck boards may be any of the full deck boards 110, 210, 310, 410 and 510 as described herein may be provided 806 according to the method of manufacturing 800. Representative width and length measurements of exemplary full deck boards may be as shown in FIGS. 1, 4 or 18, according to particular embodiments of method 800. Method 800 may further include providing a plurality of short deck boards 808 of a predetermined width, w_{sd}, and a predetermined length, I_{sd}. According to embodiments of method 800, any of the short deck boards 112, 212, 312, 412, 512 and 612 described herein may be provided in method step 808.

Method 800 may further include disposing each of the two outer stringers 810 a predetermined distance apart from and parallel to the at least one intermediate stringer as measured from a centerline of the at least one intermediate stringer to a centerline of an adjacent outer stringer. For example and not by way of limitation, the predetermined distance in method step 810 may be, a, as shown in FIG. 2; b, as shown in FIG. 5; or s₁, as shown in FIG. 19. However, it will be understood that the predetermined distance may be any suitable distance for the intended application of the pallet being manufactured in accordance with method 800.

Method 800 may further include forming a top deck 812 comprising at least two full deck boards and at least two short deck boards. Exemplary configurations of top decks that may be formed according to method step 812 are top decks 102, 202, 402, 502 and 602 disclosed herein. However, it will be understood that any suitable top deck formed according to the principles disclosed herein may be suitable for the method of manufacturing a pallet 800. According to a particular feature of the pallets manufactured according to method 800, each short deck board extends between top surfaces of two adjacent stringers without extending beyond the two adjacent stringers according to one embodiment of method 800, e.g., see 112, FIG. 1, 212, FIG. 4 and 612, FIG. 18. Again, method 800 contemplates manufacturing a pallet having the end-to-end short deck boards configuration shown, e.g., in FIGS. 1-3 and 18-20, as well as manufacturing a pallet having the interleaved or interdigitated short deck board configuration shown, e.g., in FIGS. 4-6.

Method 800 may further include forming a bottom deck 814 comprising at least two full deck boards and at least two short deck boards. Again, according to a particular feature of the pallets manufactured according to method 800, each short deck board extends from bottom surfaces of two adjacent stringers without extending beyond the two adjacent stringers, in a manner similar to that shown for top decks. It will also be understood that bottom decks may be of the end-to-end short deck board configuration, or of the interdigitated short deck board configuration as disclosed herein. Finally, method 800 may further include fastening the top deck and the bottom deck to the stringers 816. Fastening may be achieved using any suitable fastener, bracket or adhesive as described herein.

According to yet another embodiment of method 800, forming a deck (top or bottom) may include short deck boards disposed end-to-end at the at least one intermediate stringer, like the short deck boards shown in FIGS. 1 and 18. According to still another embodiment of method 800, forming a deck may include short deck boards disposed adjacent to one another in an interdigitated configuration at the at least one intermediate stringer, like the short deck boards shown in FIG. 4. It will also be understood that interdigitated short deck boards shown in FIG. 4 may be extended to multiple intermediate stringer pallet configurations such as the dual intermediate stringer 608 configuration shown in FIG. 18. According to other embodiments, intermediate stringer thickness, tᵢ, of the at least one intermediate stringer may be of standard thickness, or greater than 2″, or greater than 3″ or any other suitable thickness, laminated or integral as disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A pallet, comprising:
a top deck;
a bottom deck parallel to, and spaced apart from, the top deck;
two outer stringers both attached between the top deck and the bottom deck and parallel to each other; and
at least one intermediate stringer disposed between and parallel to the two outer stringers, wherein the at least one intermediate stringer is thicker than either of the two outer stringers.

2. The pallet according to claim 1, wherein the top deck comprises a plurality of parallel full deck boards, wherein at least one of the plurality of full deck boards comprises at least two short deck boards disposed end-to-end at the at least one intermediate stringer.

3. The pallet according to claim 2, wherein two outermost parallel full deck boards are integral and all innermost full deck boards comprise two short deck boards disposed end-to-end at a single intermediate stringer.

4. The pallet according to claim 1, wherein the bottom deck comprises a plurality of parallel full deck boards, wherein at least one of the plurality of full deck boards comprises at least two short deck boards joined end-to-end at the at least one intermediate stringer.

5. The pallet according to claim 4, wherein two outermost parallel full deck boards are integral and all innermost full deck boards comprise two short deck boards disposed end-to-end at the intermediate stringer.

6. The pallet according to claim 1, wherein the two outer stringers each comprise a predetermined length, Iₛ, of nominally 2″×4″ lumber.

7. The pallet according to claim 1, wherein at least one of the stringers comprises two short stringer boards joined end-to-end with two metal plates.

8. The pallet according to claim 1, wherein the two outer stringers each comprise two fork blade slots disposed along a bottom surface.

9. The pallet according to claim 1, wherein the at least one intermediate stringer comprises a length, Iₛ, of nominally 3″×4″ lumber.

10. The pallet according to claim 1, wherein the at least one intermediate stringer comprises two identical lengths of nominally 2″×4″ lumber joined together to form the identical length of a laminated intermediate stringer having dimensions of about 4″×about 4″.

11. The pallet according to claim 1, wherein the at least one intermediate stringer comprises two identical lengths of nominally 1″×4″ lumber attached to opposing sides of the identical length of a nominally 2″×4″ lumber to form an identical length of a laminated intermediate stringer having dimensions of about 4″× about 4″.

12. The pallet according to claim 1, wherein the at least one intermediate stringer comprises a length of nominally 4″×4″ lumber.

13. The pallet according to claim 1, wherein the at least one intermediate stringer comprises two short lengths of nominally 3″×4″ lumber formed into short stringer boards joined together end-to-end with two metal plates.

14. The pallet according to claim 1, comprising approximate dimensions selected from the group consisting of: 48″×40″, 48″×48″, 42″×42″, 36″×36″, 56″×44″, 48″×42″, 1.2 m×1.0 m and 1.2 m×0.8 m.

15. The pallet according to claim 1, wherein the at least one intermediate stringer comprises a single intermediate stringer.

16. The pallet according to claim 1, wherein the at least one intermediate stringer comprises two intermediate stringers evenly spaced between the two outer stringers.

17. The pallet according to claim 1, wherein one of the decks comprises a medium deck board joined end-to-end with a short deck board at the at least one intermediate stringer.

18. A pallet, comprising:
a top deck;
a bottom deck parallel and spaced apart from the top deck;
two outer stringers both attached between the top deck and the bottom deck and parallel to each other;
an intermediate stringer disposed between and parallel to the two outer stringers; and
wherein the decks both further comprise short deck boards spanning from an outer stringer to the intermediate stringer without extending beyond the intermediate stringer.

19. The pallet according to claim 18, wherein two short deck boards are disposed end-to-end at the intermediate stringer.

20. The pallet according to claim 18, wherein the short deck boards extend from the outer stringers to the intermediate stringer in an interdigitated relationship.

21. The pallet according to claim 18, wherein the intermediate stringer is thicker than either of the outer stringers.

22. The pallet according to claim 18, wherein the intermediate stringer comprises two nominally 2″×4″ boards joined together to form a composite intermediate stringer having dimensions of about 4″× about 4″.

23. The pallet according to claim 18, wherein the intermediate stringer comprises a length of nominally 4″×4″ board.

24. The pallet according to claim 18, wherein the intermediate stringer comprises a nominally 2″×4″ board surrounded and joined by two nominally 1″×4″ boards, thereby forming a composite intermediate stringer having dimensions of about 4″× about 4″.

25. The pallet according to claim 18, wherein the intermediate stringer comprises two short nominally 4″×4″ stringer boards joined end-to-end with steel plates to form a composite nominally 4″×4″ intermediate stringer.

26. A method of manufacturing a pallet, the method comprising: providing two outer stringers of a predetermined length, Iₛ;
providing at least one intermediate stringer of the predetermined length, Iₛ, the at least one intermediate stringer comprising a thickness, tᵢ, greater than a thickness, tₒ, corresponding to either of the two outer stringers;
providing a plurality of full deck boards of a predetermined width, w_{fd}, and a predetermined length, I_{fd};
providing a plurality of short deck boards of a predetermined width, w_{sd}, and a predetermined length, I_{sd};
disposing each of the two outer stringers a predetermined distance apart from and parallel to the at least one intermediate stringer as measured from a centerline of the at least one intermediate stringer to a centerline of an adjacent outer stringer;
forming a top deck, comprising at least two full deck boards and at least two short deck boards, each short deck board extending between top surfaces of two adjacent stringers without extending beyond the two adjacent stringers;
forming a bottom deck, comprising at least two full deck boards and at least two short deck boards, each short deck board extending from bottom surfaces of two adjacent stringers without extending beyond the two adjacent stringers; and
fastening the top deck and the bottom deck to the stringers.

27. The method according to claim 26, wherein forming a deck further comprises short deck boards disposed end-to-end at the at least one intermediate stringer.

28. The method according to claim 26, wherein forming a deck further comprises short deck boards disposed adjacent to one another in an interdigitated configuration at the at least one intermediate stringer.

29. The method according to claim 26, wherein the thickness, tᵢ, of the at least one intermediate stringer is greater than 2″.

30. The method according to claim 26, wherein the thickness, tᵢ, of the at least one intermediate stringer is greater than 3″.

31. The method according to claim 26, wherein the method is performed in the order recited in claim 25.
